(19) United States
(12) Patent Application Publication
(10) Pub. No.: US 2022/0298801 A1
(43) Pub. Date: Sep. 22, 2022

(54) JOINT TAPE

(71) Applicants: Knauf Gips KG, Iphofen (DE); 3D Coatings GmbH & Co. KG, Reichenberg (DE)

(72) Inventors: Stefan Pointl, Gmunden (AT); Robert Stubits, Wien (AT); Andreas Wilhelm, Pilsting (DE); Simon Philipp, Würzburg (DE); Andreas Marquardt, Güntersleben (DE); Michael Viebahn, Iphofen (DE); Matthias Schäfer, Bütthard (DE)

(21) Appl. No.: 17/432,373

(22) PCT Filed: Feb. 19, 2019
(86) PCT No.: PCT/EP2019/000049

§ 371 Date: Aug. 19, 2021

(51) Int. Cl. E04F 13/04; C09J 7/24; C09J 7/38

(52) U.S. Cl. CPC E04F 13/042; C09J 7/241; C09J 7/383; E04B 2001/8466

(57) ABSTRACT

Joint tape 1 for attachment to a ceiling or a wall, the joint tape 1 comprising a layer of permeable non-woven material 2 and an adhesive layer 3 attached to the permeable non-woven material 2, the adhesive layer 3 being applied to one side of the non-woven material in a pattern comprising sections 21 without adhesive applied thereto and wherein the joint tape 1 has a width of 3 mm to 20 mm.

The invention relates to a joint tape, especially for attachment to a ceiling or a wall, in particular to an acoustic ceiling made of perforated budding panels, a method for providing building panels with a joint tape, and the use of a joint tape.

In the technical field of interior constructions for buildings, it is known to apply perforated building panels (e.g. perforated gypsum plasterboards, perforated boards made of other materials as for example ply wood), specifically in the construction of acoustic ceilings. Perforated building panels usually have a sharp edge and not an otherwise frequently encountered bevel. However, it is difficult to provide an acoustic ceiling with closed (or sealed) joints using perforated building panels.

It is known to provide joint tapes and crack bridges in the field of drywall but, however, they were never applied for acoustic ceiling systems comprising perforated building panels: the joint tapes or crack bridges that are used in connection with the treatment of joints (or gaps) between conventional gypsum plasterboards, gypsum fiber boards or other building panels are either resistant to tearing and then usually too wide and too thick and thus need to be plastered over a large area, or be incorporated into joint cavities. Both cannot be realized constructively in perforated ceiling systems.

Further, the connection of two perforated building panels is usually done by adhesives, especially liquid glue, or by joint fillers. However, both options are time consuming, since they require several working steps (e.g. sanding, removing dust, gluing, drying) and, the application of adhesives or joint fillers is unclean and requires preparation for example by the covering of the floor at the construction site.

For example, for an acoustic ceiling with closed (or sealed) joints using perforated building panels, the preparation of the joints between two building panels starts with sanding of the area around the joint and wiping the sanded area with a damp dish or sponge to remove the dust and debris from the sanding step. Liquid glue is applied by a roller and a joint tape is attached such that the joint (or gap) is completely covered, Thereafter, the liquid glue can be applied to the attached joint tape to provide a surface, which can be painted to finish the surface.

A disadvantage related to this technique is that the joint tape is applied by use of a gluing substance. The application of glue is time consuming because two separate steps have to be performed. In particular, after the first application, the first glue layer needs to dry and cure completely. In general, the application of glue is unclean and requires preparation for example by the covering of the floor at the construction site. Moreover, it requires high working precision to install a joint tape in this way, which extends over the entire ceiling surface. That makes the installation time consuming on site.

The object of the invention is therefore to provide a joint tape which overcomes or at least reduces the disadvantages known from the prior art and in particular a joint tape which can be installed quickly and which can be applied without the use of additional, especially liquid, adhesives.

The problem is solved by a joint tape for attachment to a ceiling or a wall, the joint tape comprising a layer of permeable nonwoven material and an adhesive layer attached to the permeable non-woven material, the adhesive layer being applied to one side of the non-woven material in a pattern comprising sections without adhesive applied thereto, and wherein the joint tape has a width of 3 mm to 20 mm. Preferred technical aspects form the subject matter of the respective dependent claims.

The invention comprises a joint tape for attachment to a ceiling or a wall. The joint tape comprises a layer of permeable nonwoven material and an adhesive layer attached to the permeable non-woven material or fleece. The adhesive layer is applied to one side of the non-woven material in a pattern comprising sections without adhesive applied thereto. The non-woven material is a (sheet-like) web of entangled fibers bonded together which is permeable for the penetration of fluids. The adhesive layer comprises an adhesive capable of adhering to the joint tape and of bonding with the outer surface of building panels in order to attach the joint tape to the ceiling or the wall. The pattern with sections without adhesive allows for the penetration of e.g. a paint or a joint filler through the permeable non-woven material to form a contact with the building panel. Hence, additional bonding for the joint tape to the ceiling is provided by the paint or the joint filler, which is attached on the joint tape after installation. This joint tape can be installed dry and quickly by only attaching the joint tape to the building panels. Since no individual step of applying an (liquid) adhesive is required, the joint tape can be applied cleanly and no pre-arrangements, like covering the floor, are required before the installation.

According to a preferred technical aspect of the invention, the adhesive layer is a self-adhesive layer. Such a self-adhesive layer comprises an adhesive, which forms a bond between the non-woven material and the building panel by pressing the joint tape against the building panel. The self-adhesive is chosen to be capable of adhering to the non-woven material and of bonding it with sufficient strength to the surface of the building panel.

Another technically preferred aspect relates to the adhesive layer, which has a weight in the range of 3 to 60 g/m². This range for the weight (per area) of the adhesive layer allows for providing an adhesive layer with enough adhesive material to achieve a sufficient bonding strength to attach the joint tape at the surface of the building panel. The upper limit is chosen according to the requirement of a limited overall thickness of the joint tape, which prevents the occurrence of visible edges at the border of the installed joint tape. The edge between joint tape and regular board surface shall be optically unobtrusive. However, if such an unobtrusive appearance is not required, a higher grammage is suitable as well.

It is preferred if the adhesive layer comprises a regular pattern of glue, e.g. in the form of dots. However, stripes or waveforms are generally also applicable. The regular pattern has advantages during the production as they can be applied via rotary printing like rotary flexo, rotary gravure or rotary screen-printing in a continuous manner, i.e. for reel to reel production methods.

According to a preferred aspect each glue dot has an identical size, preferable having a diameter in the range between 0.1 to 4.0 mm preferably between 0.1 to 2.0 mm. This diameter size ensures that at the same time a sufficient adherence to the non-woven material and the building board is achieved. At the same time, the contours of the individual glue dots are preferably not visible through the attached joint tape.

It is moreover of advantage if the regular pattern comprises 25 to 15625 glue dots per 625 mm², preferably 100 to 6400 glue dots per 625 mm². These values for the number of glue dots relate in particular to the technique for the application via rotary screen-printing, wherein for example the number of 25 comprises 5 glue dots arranged equidistant along a line having the length of one inch (wherein 1 inch equals 2.54 cm).

The adhesive layer can be applied as regular pattern comprising glue stripes or as irregular pattern comprising glue stripes. Pattern which comprise stripes whether they are regular or irregular allow for the penetration of paint or joint filler because of they provide sections without applied adhesive. In principle, the stripe pattern can be combined with the dot pattern.

According to another preferred aspect, the adhesive layer comprises a polymer material.

Another advantageous aspect relates to the polymer material comprising at least one of the group of acrylates and rubber. The rubber is preferably a synthetic rubber. However, UV curing acrylates result in a good light constancy/resistance.

It is particularly preferred that the adhesive layer comprises a hot melt adhesive (e.g. synthetic rubber, UV-curing acrylates), a (dried) dispersion-based adhesive (e.g. acrylic adhesives) or a solvent-based adhesive (e.g. acrylic adhesive).

Another advantageous aspect relates to the layer of the permeable non-woven material comprising a non-woven material of at least 30 to 100 weight-% of glass-, mineral-, carbon- or synthetic-fibers. This range as well as the selection of materials is chosen to provide a non-woven material with sufficient dimensional stability over a long period in order to avoid cracks at the edge of the installed joint tape. Further, these materials ensure low shrinking of the tape from the wet to the dry state.

Preferably, the layer of the permeable non-woven material has a grammage in the range of 10 to 70 g/m². The grammage of the non-woven material is chosen so that if a paint is applied at the construction site with a standard roller the edge of the applied joint tape appears virtually invisible for a viewer in a room after the application of the paint. The same is true if a joint filler is applied.

Preferably, the layer of permeable non-woven material has a thickness of 8 to 40 μm. The thickness of the non-woven material is chosen in view of the same requirements considered for the grammage.

Particularly advantageous is if the layer of permeable non-woven material has an air permeability of 1000 to 15000 l/(m²s). This range for the air permeability provides a non-woven material, which can be penetrated by e.g. a liquid paint or a joint filler applied to the joint tape to get in contact with the surface of the building board in a manner to provide for sufficient adherence.

Another technically preferred aspect relates to that the joint tape has a grammage of 15 to 100 cm². The grammage range is chosen so that the edge of the applied joint tape is not visible for a viewer in a room, especially when painted over or a joint filler is applied.

The same applies for the preferred range for the thickness of the joint tape of 15 to 80 μm, Those values allow for providing a joint tape, which can be applied without visible edge.

Advantageously, the air permeability of the joint tape is 2000 to 7000 l/(m²s). The combined air permeability comprises the air permeability of the adhesive layer and the non-woven material and allows for the sufficient penetration of paint or joint filler.

Preferably, the joint tape has a width of 4 mm to 15 mm, more preferably of 5 to 10 mm, even more preferably of 7 to 9 mm, most preferably of 8 mm. This range allows for providing non-perforated plain borders and perimeters, preferably for acoustic ceilings.

Another aspect of the invention relates to a method for providing a closed surface of building panels. The method comprises the steps of:
providing a surface of (e.g. perforated) building panels; (and thereafter)
applying a joint tape, preferably an self-adhesive joint tape (as described above), to the joints of the surface of building panels; (and thereafter)
applying a paint or a joint filler covering at least the edge of the joint tape and the adjacent building panels comprising the joint tape; and (thereafter)
optionally sanding the edge area of the joint tape.

In another aspect, the invention relates to the use of a joint tape as described above for sealing joints on a surface of building panels, preferably of perforated building panels.

In the following, the invention will be explained in more detail with reference to drawings. Like reference numerals denote similar features throughout the drawings.

The drawings show:

FIG. 1 top view of a section of a joint tape for attachment to a ceiling according to the invention;

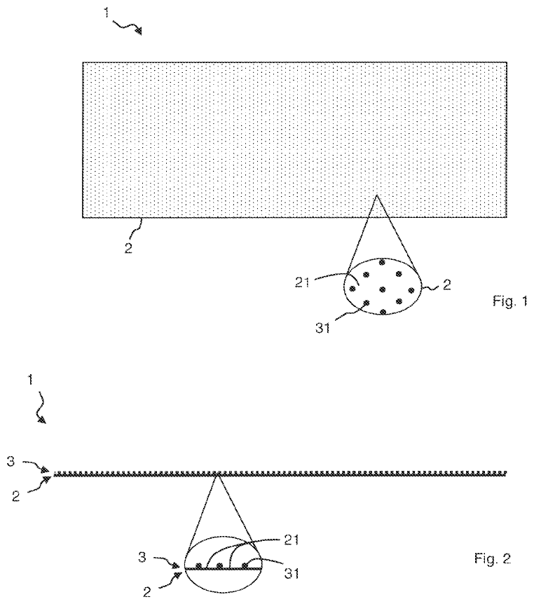

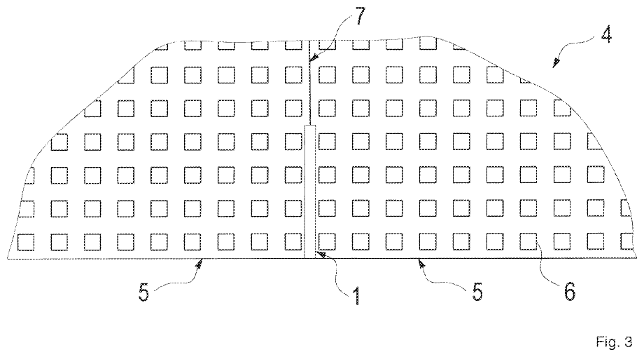

FIG. 2 side view of the joint tape shown in FIG. 1; and

FIG. 3 cutout of an acoustic ceiling having a joint tape applied on top of the joint of two perforated building panels.

In FIG. 1 a section of a joint tape 1 for attachment to a (acoustic) ceiling is illustrated. Such a section for example can be cut from a roll in which joint tape 1 is available in the market. Joint tape 1 comprises a layer of permeable non-woven material 2 and an adhesive layer 3 attached to the non-woven material 2.

The application of the illustrated joint tape 1 to a layer of building boards requires no liquid adhesive during the installation so that the application is clean and no pre-arrangements, like covering the floor, are required before the installation.

In the shown example, the non-woven material comprises synthetic fibers, which provide dimensional stability. The grammage of the non-woven is in the illustrated example in the range of 10 to 70 g/m². The permeable non-woven material 2 has a thickness of 8 to 40 μm while providing an air permeability in the range of 1000 to 15000 l/(m²s).

The adhesive layer 3 is arranged at one side of the non-woven material 2 in a regular pattern of glue dots 31. In the illustrated example, the adhesive layer 3 has a weight of 3 to 60 g/m², The pattern comprises glue dots 31, preferably of an identical size, which are arranged in an amount in the range of 25 to 15625 glue dots per 625 mm². The adhesive may be a hot melt adhesive made of an UV-light curable acrylic polymer material.

The circular area 2 shows an enlarged section of the joint tape 1 in the top view. It illustrates areas 21 without adhesive applied thereto and glue dots 31.

In a particular example, the joint tape 1 as shown in FIG. 1 is made of a non-woven material 2 “Vlies VILEDON T 1790C” available in the market from Freudenberg Viiesstoffe/Weinheim consisting of 100% glass fiber, 30 g/m² weight/area and an air permeability of about 8.000 l/(m²×s) (measured with AKUSTRON from rycobel group ib-walther/Uffenheim).

An adhesive layer 3 is applied to the exemplified non-woven material 2, the adhesive layer 3 having a weight/area in the range of 2.0 to 2.5 g/m² and is a hot melt adhesive e.g. “Technomelt 8783” from Henkel/Düsseldorf. The adhesive layer 3 is applied with a 20 dpi-pattern of glue dots 31 so that the air permeability of the adhesive layer 3 is about 6.000 l/(m²s) determined by the above mentioned AKUSTRON device. The joint tape 1 has in this specific example a width of 8 mm.

The adhesive layer 3 can be covered and protected by the silicone layer of a one side siliconized paper (not shown), e.g. RB065/2 from Cotek Papers Ltd/Draycott, Great Britain, in order to allow for rolling up of the joint tape. The protective siliconized paper has to be removed before applying the joint tape to a ceiling or a wall.

The particular combination of non-woven material 2 and adhesive layer 3 that is shown in FIG. 1 is preferred, but generally, the non-woven material 2 and the adhesive layer 3 can be combined without restriction within the above-mentioned ranges.

In FIG. 2 a side view of a section of the joint tape 1 for attachment to a ceiling or a wall is illustrated. In the side view, as well, can be seen that the joint tape 1 comprises a layer of permeable non-woven material 2 and an adhesive layer 3 attached to the non-woven material 2. In the circle 2 below, an enlarged section of the joint tape 1 is illustrated in the side view, which gives a detailed illustration of the thickness of the adhesive joint tape 1, which can be in the range of 15 to 80 μm and the thickness of the permeable non-woven material 2 which is in the range of 8 to 40 urn.

In FIG. 3 a cutout of an acoustic ceiling 4 having a joint tape 1 applied on two building panels 5 with perforations 6. The joint tape 1 explained in connection with the foregoing figures is attached to an acoustic ceiling. The acoustic ceiling is installed by the method described herein which starts with providing a (plurality of) perforated building panel(s) 5,6 to form the ceiling surface.

Thereafter, joint tape 1 is applied to the joints 7 for selectively covering the joints (or gaps) between the building panels 5.

Thereafter paint or a joint filler is applied to the attached joint tape 1 and at least part of the ceiling surface (uncovered building boards) to firmly attach the joint tape 1 to the building panels and to obscure the edge of joint tape 1, Finally, the edge (area) of joint tape 1 can be sanded.

However, for clarification reasons in FIG. 3 the edges of joint tape 1, which are obscured according to the method described herein, are shown.

In a specific example, the joint tape is attached to an acoustic ceiling made of plasterboards which are available in the market as CLEANEO CLASSIC 8/18R (Knauf Gips KG/Iphofen).

For example, the applied joint tape is covered either by the paint KNAUF INTOL (Knauf Gips KGilphofen) or by the joint filler KNAUF UNIFLOTT FINISH (Knauf Gips KG/Iphofen).

1. Joint tape for attachment to a ceiling or a wall, the joint tape comprising a layer of permeable non-woven material and an adhesive layer attached to the permeable non-woven material, the adhesive layer being applied to one side of the non-woven material in a pattern comprising sections without adhesive applied thereto, and wherein the joint tape has a width of 3 mm to 20 mm.

2. Joint tape according to claim 1, wherein the adhesive layer is a self-adhesive layer.

3. Joint tape according to claim 1, wherein the adhesive layer has a weight in the range of 3 to 60 g/m².

4. Joint tape according to claim 1, wherein the adhesive layer comprises a regular pattern of glue dots.

5. Joint tape according to claim 4, wherein each glue dot has an identical size, preferably having a diameter in the range between 0.1 to 4.0 mm, preferably between 0.1 to 2.0 mm.

6. Joint tape according to claim 4, wherein the regular pattern comprises 25 to 15625 glue dots per 625 mm², preferably 100 to 6400 glue dots per 625 mm².

7. Joint tape according to claims 1 to 3, wherein the adhesive layer is applied as a regular pattern comprising glue stripes or as an irregular pattern comprising glue stripes.

8. Joint tape according to claim 1, wherein the adhesive layer comprises a polymer material and wherein the polymer material preferably comprises at least one of the group of acrylates and rubber.

9. Joint tape according to claim 8, wherein the adhesive layer comprises a hot melt adhesive, a dispersion-based adhesive or a solvent-based adhesive.

10. Joint tape according to claim 1, wherein the layer of permeable non-woven material comprises a non-woven material of at least 30 to 100 weight-% of glass-, mineral-, carbon- or synthetic-fibers.

11. Joint tape according to claim 1, wherein the joint tape has a grammage of 15 to 100 g/m² and/or a thickness of 15 to 80 μm.

12. Joint tape according to claim 1, wherein the air permeability of joint tape is 2000 to 7000 l/m²s.

13. Joint tape according to claim 1, wherein the joint tape has a width of 4 mm to 15 mm, preferably of 5 to 10 mm, more preferably of 7 to 9 mm, most preferably of 8 mm.

14. Method for providing a closed surface of building panels comprising the steps of:
providing a surface of building panels;
applying a joint tape according to any one of the preceding claims to the joints of the surface of building panels;
applying a paint or a joint filler covering at least the edge of the joint tape and the adjacent building panels comprising the joint tape; and
optionally sanding the edge area of the joint tape.

15. Use of a joint tape according to claim 1 for sealing joints on a surface of building panels.
